(19) United States
(12) Patent Application Publication
(10) Pub. No.: US 2021/0155774 A1
(43) Pub. Date: May 27, 2021

(54) BLENDS OF CROSSLINKING AGENTS FOR FLUOROELASTOMERS

(71) Applicant: 3M INNOVATIVE PROPERTIES COMPANY, St Paul, MN (US)

(72) Inventors: Jiyoung Park, Woodbury, MN (US); Klaus Hintzer, Kastl (DE); Tatsuo Fukushi, Woodbury, MN (US); Chetan P. Jariwala, Woodbury, MN (US); Miguel A. Guerra, Woodbury, MN (US)

(21) Appl. No.: 17/045,670

(22) PCT Filed: Feb. 26, 2019
(86) PCT No.: PCT/IB2019/051529

§ 371 Date: Oct. 6, 2020

Related U.S. Application Data
(60) Provisional application No. 62/655,314, filed on Apr. 10, 2018.

(51) Int. Cl. C08K 13/02

(52) U.S. Cl. CPC C08K 13/02

(57) ABSTRACT

Provided is a curable composition comprising a partially fluorinated fluoropolymer and a crosslinking component comprising a blend of a polysulfonamide compound and a fluorinated polyamine compound.

### BACKGROUND

Fluoropolymers are a commercially important class of materials that include, for example, crosslinked and uncrosslinked fluorocarbon elastomers and semi-crystalline or glassy fluorocarbon plastics.

Fluorocarbon elastomers, particularly the copolymers of vinylidene fluoride with other ethylenically unsaturated halogenated and non-halogenated monomers, such as hexafluoropropene, have particular utility in high temperature applications, such as seals, gaskets, and linings. See, for example, R. A. Brullo, “Fluoroelastomer Rubber for Automotive Applications,” Automotive Elastomer & Design, June 1985, “Fluoroelastomer Seal Up Automotive Future,” Materials Engineering, October 1988, and W. M. Grootaert, et al., “Fluorocarbon Elastomers,” Kirk-Othmer, Encyclopedia of Chemical Technology, Vol. 8, pp. 990-1005 (4^{th} ed., John Wiley & Sons, 1993).

### SUMMARY

There is a desire to identify a novel curing system for partially fluorinated fluoropolymers. In one aspect, a curable partially fluorinated polymer composition is disclosed comprising:

(i) a partially fluorinated amorphous fluoropolymer, wherein the partially fluorinated fluoropolymer comprises carbon-carbon double bonds or is capable of forming carbon-carbon double bonds along the partially fluorinated amorphous fluoropolymer; and

(ii) a curing agent composition comprising a blend of fluorinated polyamine compound (and salts thereof) and a polysulfonamide compound.

As used herein, “alkyl” and “alkylene” mean the monovalent and divalent residues remaining after removal of one and two hydrogen atoms, respectively, from a linear or branched chain hydrocarbon having 1 to 20 carbon atoms. Examples of “alkyl” as used herein include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, and norbornyl and the like. Unless otherwise noted, alkyl groups may be mono- or polyvalent.

“fluorinated” refers to hydrocarbon compounds that have one or more C—H bonds replaced by C—F bonds;

“fluoroalkyl has essentially the same meaning as “alkyl” except that one or more of the hydrogen atoms of the alkyl radical are replaced by fluorine atoms; e.g. partially fluorinated alkylene.

“fluoroalkylene has essentially the same meaning as “alkylene” except that one or more of the hydrogen atoms of the alkyl radical are replaced by fluorine atoms.

“Perfluoroalkyl” has essentially the same meaning as “alkyl” except that all or essentially all of the hydrogen atoms of the alkyl radical are replaced by fluorine atoms, e.g. perfluoropropyl, perfluorobutyl, perfluorooctyl, and the like.

“Perfluoroalkylene” has essentially the same meaning as “alkylene” except that all or essentially all of the hydrogen atoms of the alkylene radical are replaced by fluorine atoms, e.g., perfluoropropylene, perfluorobutylene, perfluorooctylene, and the like.

Perfluoroether and perfluoropolyether refers to perfluoroalkyl or perfluoroalkylene where the perfluorinated carbon chain contains one or more ether oxygen atoms; e.g. CF₃CF₂OCF₂CF₂—, CF₃CF₂O(CF₂CF₂O)₃CF₂CF₂—, C₃F₇O(CF(CF₃)CF₂O)ₛCF(CF₃)CF₂—, where s is (for example) from about 1 to about 50, and —CF₂OCF₂—, or —[CF₂—CF₂—O]ᵣ—[CF(CF₃)—CF₂—O]ₛ—; wherein r and s are (for example) integers of 1 to 50.

### DETAILED DESCRIPTION

In the present disclosure, it has been found that a partially fluorinated fluoropolymer can be cured with a blend of a polyamine and a polysulfonamide compound.

Using the blend of fluorinated polyamine and polysulfonamide, Applicants achieve a faster cure rate compared with polysulfonamide alone, better physical properties and compression set % compared with polysulfonamide, better processability without scorch issue (scorch time is tunable) compared with the polyamine alone and better control of the physical properties and the values of compression set.

The amorphous fluoropolymers of the present disclosure are partially fluorinated polymers. As disclosed herein, an amorphous partially fluorinated polymer is a polymer comprising at least one carbon-hydrogen bond and at least one carbon-fluorine bond on the backbone of the polymer. In one embodiment, the amorphous partially fluorinated polymer is highly fluorinated, wherein at least 60, 70, 80, or even 90% of the polymer backbone comprises C—F bonds.

The amorphous fluoropolymer of the present disclosure also comprises carbon-carbon double bonds and/or is capable of forming carbon-carbon double bonds along the polymer chain. In one embodiment, the partially fluorinated amorphous fluoropolymer comprises carbon-carbon double bonds along the backbone of the partially fluorinated amorphous fluoropolymer or is capable of forming carbon-carbon double bonds along the backbone of the partially fluorinated amorphous fluoropolymer. In another embodiment, the partially fluorinated amorphous fluoropolymer comprises carbon-carbon double bonds or is capable of forming carbon-carbon double bonds in a pendent group off of the backbone of the partially fluorinated amorphous fluoropolymer.

The fluoropolymer capable of forming carbon-carbon double bonds means that the fluoropolymer contains units capable of forming double bonds. Such units include, for example, two adjacent carbons, along the polymer backbone or pendent side chain, wherein a hydrogen is attached to the first carbon and a leaving group is attached to the second carbon. During an elimination reaction (e.g., thermal reaction, and/or use of acids or bases), the leaving group and the hydrogen leave forming a double bond between the two carbon atoms. An exemplary leaving group includes: a fluoride, an alkoxide, a hydroxide, a tosylate, a mesylate, an amine, an ammonium, a sulfide, a sulfonium, a sulfoxide, a sulfone, and combinations thereof. Those fluoropolymer capable of forming carbon-carbon bonds generally have the structure —CH—CX—, where X is a leaving groups such that when treated with base will provide the requisite unsaturation. In many embodiments the polymer has —CH—CF— in the backbone, which may be dehydrofluorinated.

The amorphous fluoropolymer comprises a plurality of these groups (carbon-carbon double bonds or groups capable of forming double bonds) to result in a sufficient cure. Generally, this means at least 0.1, 0.5, 1, 2, or even 5 mole percent; at most 7, 10, 15, or even 20 mole percent (i.e., moles of these carbon-carbon double bonds or precursors thereof per mole of polymer).

In one embodiment, the amorphous partially fluorinated polymer is derived from at least one hydrogen containing monomer such as vinylidene fluoride.

In one embodiment, the amorphous fluoropolymer comprises adjacent copolymerized units of vinylidene fluoride (VDF) and hexafluoropropylene (HFP); copolymerized units of VDF (or tetrafluoroethylene) and a fluorinated comonomer capable of delivering an acidic hydrogen atom to the polymer backbone, such as trifluoroethylene; vinyl fluoride; 3,3,3-trifluoropropene-1; pentafluoropropene (e.g., 2-hydropentafluoropropylene and 1-hydropentafluoropropylene); 2,3,3,3-tetrafluoropropene; and combinations thereof.

In some embodiments, small amounts (e.g., less than 10, 5, 2, or even 1 weight percent (wt %) of additional monomers may be added so long as the amorphous fluoropolymer is able to be cured using the curing agent disclosed herein.

In one embodiment, the amorphous fluoropolymer is additionally derived from a hydrogen containing monomer including: pentafluoropropylene (e.g., 2-hydropentafluoropropylene), propylene, ethylene, isobutylene, and combinations thereof. In one embodiment, the amorphous fluoropolymer is additionally derived from a perfluorinated monomer. Exemplary perfluorinated monomers include: hexafluoropropene; tetrafluoroethylene; chlorotrifluoroethylene; perfluoro(alkylvinyl ether) such as perfluoromethyl vinyl ether, CF₂═CFOCFCF₂CF₂OCF₃, CF₂═CFOCF₂OCF₂CF₂CF₃, CF₂═CFOCF₂OCF₂CF₃, CF₂═CFOCF₂OCF₃, and CF₂═CFOCF₂OC₃F₇, perfluoro(alkylallyl ether) such as perfluoromethyl allyl ether, perfluoro(alkyloxyallyl ether) such as perfluoro-4,8-dioxa-1-nonene (i.e., CF₂═CFCF₂O(CF₂)₃OCF₃, and combinations thereof.

Exemplary types of polymers include those comprising interpolymerized units derived from (i) vinylidene fluoride, tetrafluoroethylene, and propylene; (ii) vinylidene fluoride, tetrafluoroethylene, ethylene, and perfluoroalkyl vinyl ether, such as perfluoro(methyl vinyl ether); (iii) vinylidene fluoride with hexafluoropropylene; (iv) hexafluoropropylene, tetrafluoroethylene, and vinylidene fluoride; (v) hexafluoropropylene and vinylidene fluoride, (vi) vinylidene fluoride and perfluoroalkyl vinyl ether; (vii) vinylidene fluoride, tetrafluoroethylene, and perfluoroalkyl vinyl ether, (viii) vinylidene fluoride, perfluoroalkyl vinyl ether, hydropentafluoroethylene and optionally, tetrafluoroethylene; (ix) tetrafluoroethylene, propylene, and 3,3,3-trifluoropropene; (x) tetrafluoroethylene, and propylene; (xi) ethylene, tetrafluoroethylene, and perfluoroalkyl vinyl ether, and optionally 3,3,3-trifluoropropylene; (xii) vinylidene fluoride, tetrafluoroethylene, and perfluoroalkyl ally ether, (xiii) vinylidene fluoride and perfluoroalkyl allyl ether; (xiv) ethylene, tetrafluoroethylene, and perfluoroalkyl vinyl ether, and optionally 3,3,3-trifluoropropylene; (xv) vinylidene fluoride, tetrafluoroethylene, and perfluoroalkyl allyl ether; (xvi) vinylidene fluoride and perfluoroalkyl allyl ether; (xvii) vinylidene fluoride, tetrafluoroethylene, and perfluoroalkyloxyallyl ether; (xviii) vinylidene fluoride and perfluoroalkyloxyallyl ether; (xiv) vinylidene fluoride, tetrafluoroethylene, and perfluoroalkyloxyallyl ether; (xv) vinylidene fluoride and perfluoroalkyloxyallyl ether; (xvi) chlorotrifluoroethylene and vinylidine fluoride; (xvii) vinylidene fluoride and 2,3,3,3-tetrafluoropropene; and combinations thereof.

Advantageously, by using the curing agent blend disclosed herein, the amorphous fluoropolymers of the present disclosure can be cured without the need for pendent bromine, iodine, or nitrile cure sites along the polymer backbone. Often, the iodine and bromine-containing cure site monomers, which are polymerized into the fluoropolymer and/or the chain ends, can be expensive. The amorphous fluoropolymer of the present disclosure is substantially free of I, Br, and nitrile groups, wherein the amorphous fluoropolymer comprises less than 0.1, 0.05, 0.01, or even 0.005 mole percent relative to the total polymer.

In one embodiment, the amorphous fluoropolymers of the present disclosure are non-grafted, meaning that they do not comprise pendant groups including vinyl, allyl, acrylate, amido, sulfonic acid salt, pyridine, carboxylic ester, carboxylic salt, hindered silanes that are aliphatic or aromatic tri-ethers or tri-esters. In one embodiment, the amorphous fluoropolymer does not comprise a monophenol graft.

The above described amorphous fluoropolymers may be blended with one or more additional crystalline fluoropolymers. With the instant curing compounds, the crystalline fluoropolymers may be cured into the matrix of the amorphous fluoropolymer

Commercially available vinylidene fluoride-containing fluoropolymers include, for example, those fluoropolymers having the trade designation 3M/Dyneon THV” (e.g., “THV 221GZ”, “THV 500GZ”, “THV 610GZ”, or “THV 815GZ”) as marketed by 3M, St. Paul, Minn.; “KYNAR” (e.g., “KYNAR 740”) as marketed by Arkema, Colombes, France; “HYLAR” (e.g., “HALAR ECTFE”) as marketed by Solvay S.A., Brussels, Belgium; and “3M/Dyneon” (e.g., “3M/Dyneon FC 2178”) as marketed by 3M.

Useful fluoropolymers also include copolymers of tetrafluoroethylene and propylene (TFE/P). These copolymers may have, for example, TFE monomeric units in a range of from at least about 20, 30 or 40 percent by weight up to about 50, 65, or even 80 percent by weight, with the remainder of the weight of the polymer being propylene monomeric units. Such polymers are commercially available, for example, under the trade designations “AFLAS” (e.g., “AFLAS 100H”, “AFLAS 150C”, or “AFLAS 150P”) as marketed by Asahi Glass Co. Ltd, Tokyo, Japan, or “VITON” (e.g., “VITON E-45” or “VITON A-200”) as marketed by The Chemours company, Wilmington, Del.

VDF-containing fluoropolymers can be prepared using emulsion polymerization techniques as described, for example, in U.S. Pat. No. 4,338,237 (Sulzbach et al.) or U.S. Pat. No. 5,285,002 (Grootaert), or US 20060029812 (Jing et al.), the disclosures of which are incorporated herein by reference.

The curable composition comprises a crosslinking component comprising a blend of a polysulfonamide and a fluorinated polyamine. The polysulfonamide compound of the crosslinking component is of the formula:

R²(NH—SO₂R¹)ₓ, I where

R¹ is a non-fluorinated or fluorinated group,
R² is a partially fluorinated or non-fluorinated group,
preferably at least one of R¹ and R² is a fluorinated group, and
subscript x is 2 to 8.

In some embodiments R¹ is a perfluorinated group (designated as R_{f}¹), and R² is partially fluorinated (designated as R_{f}²) or non-fluorinated (designated as Rₕ². By partially fluorinated, it is meant that the R² group contains at least one non-fluorinated carbon atoms between a fluorinated carbon and the nitrogen, egg —CF₂—CH₂—NH—. Such embodiments may be represented as:

Rₕ²(NH—SO₂R_{f}¹)ₓ, II, or

R_{f}²(NH—SO₂R_{f}¹)ₓ, III

R_{f}²(NH—SO₂Rₕ¹)ₓ, IV

In some embodiments both R¹ and R² are non-fluorinated and may be represented by the formula:

Rₕ²(NH—SO₂Rₕ¹)ₓ, V

where
Rₕ¹ is a non-fluorinated group; and
Rₕ² is a non-fluorinated group.

The R_{f}¹ groups can contain straight chain, branched chain, or cyclic monovalent fluorinated groups or any combination thereof. The R_{f}¹ groups can optionally contain one or more catenary oxygen atoms in the carbon-carbon chain so as to form a carbon-oxygen-carbon chain (i.e, a oxyalkylene group). Perfluorinated groups are generally preferred, but hydrogen or chlorine atoms can also be present as substituents, provided that no more than one atom of either is present for every two carbon atoms.

It is additionally preferred that any R_{f}¹ group contain at least about 40% fluorine by weight, more preferably at least about 50% fluorine by weight. The terminal portion of the monovalent R_{f}¹ group is generally perfluorinated, preferably containing at least three fluorine atoms, e.g., CF₃—, CF₃CF₂—, CF₃CF₂CF₂—, (CF₃)₂N—, (CF₃)₂CF—, SF₅CF₂—. In certain embodiments, monovalent perfluoroalkyl groups (i.e., those of the formula CₙF₂ₙ₊₁—) are the preferred R_{f}¹ groups, with n=2 to 8 being preferred and with n=3-5 being the most preferred.

In some embodiment the R_{f}¹ may comprise a perfluoroether or perfluoropolyether. Useful perfluoroether groups (R_{f}¹) correspond to the formula:

F—R_{f}³—O—R_{f}⁴—(R_{f}⁵)_{q}— (VI)

wherein
R_{f}³ represents a perfluoroalkylene group,
R_{f}⁴ represents a perfluoroalkyleneoxy group consisting of perfluoroalkyleneoxy groups having 1, 2, 3 or 4 carbon atoms or a mixture of such perfluoroalkyleneoxy groups,

R_{f}⁵ represents a perfluoroalkylene group and q is 0 or 1.

The perfluoroalkylene groups R_{f}³ and R_{f}⁵ formula (VI) may be linear or branched and may comprise 1 to 10 carbon atoms, preferably 1 to 6 carbon atoms. A typical monovalent perfluoroalkyl group is CF₃—CF₂—CF₂— and a typical divalent perfluoroalkylene is —CF₂—CF₂—CF₂—, —CF₂— or —CF(CF₃)—. Examples of perfluoroalkyleneoxy groups R_{f}⁴ include: —CF₂—CF₂—O—, —CF(CF₃)—CF₂—O—, —CF₂—CF(CF₃)—O—, —CF₂—CF₂—CF₂—O—, —CF₂—O—, —CF(CF₃)—O—, and —CF₂—CF₂—CF₂—CF₂—O, which may repeat, for example, from 3 to 30 times.

The perfluoroalkyleneoxy group Re may be comprised of the same perfluorooxyalkylene units or of a mixture of different perfluorooxyalkylene units. When the perfluorooxyalkylene group is composed of different perfluoroalkylene oxy units, they can be present in a random configuration, alternating configuration or they can be present as blocks. Typical examples of perfluorinated poly(oxyalkylene) groups include: —[CF₂—CF₂—O]ᵣ—; —[CF(CF₃)—CF₂—O]ₛ—; —[CF₂CF₂—O]ᵣ—[CF₂O]ₜ—, —[CF₂CF₂CF₂CF₂—O]ᵤ and —[CF₂—CF₂—O]ᵣ—[CF(CF₃)—CF₂—O]ₛ—; wherein each of r, s, t and u each are integers of 1 to 50, preferably 2 to 25. A preferred perfluorooxyalkyl group that corresponds to formula (VI) is CF₃—CF₂—CF₂—O—[CF(CF₃)—CF₂O]ₛ—CF(CF₃)CF₂— wherein s is an integer of 1 to 50.

In some embodiments R¹ may non-fluorinated (Rₕ¹) and selected from monovalent (hetero)hydrocarbyl groups including aliphatic, cycloaliphatic, aromatic or alkyl-substituted aromatic having 2 to 30 carbon atoms and optionally zero to four catenary heteroatoms of oxygen, nitrogen or sulfur; i.e. a heterohydrocarbyl group.

In some embodiments R² may non-fluorinated (Rₕ²) and selected from di- and polyvalent (hetero)hydrocarbyl groups including aliphatic, cycloaliphatic, aromatic or alkyl-substituted aromatic having 2 to 30 carbon atoms and optionally zero to four catenary heteroatoms of oxygen, nitrogen or sulfur; i.e. a heterohydrocarbyl group.

In some embodiments the R² group may be partially fluorinated and designated as R_{f}². The R_{f}² groups are di- or polyvalent and can contain straight chain, branched chain, or cyclic pendent polyvalent fluorinated groups or any combination thereof. The R_{f}² groups can optionally contain one or more catenary oxygen atoms in the carbon-carbon chain so as to form a carbon-oxygen-carbon chain (i.e. a oxyalkylene group).

The R_{f}² generally contains a perfluorinated portion and at least one non-fluorinated carbon on each terminus such as R_{f}⁶(—Y)ₓ—, where R_{f}⁶ represents a perfluoroalkylene or perfluoroether group, and Y is a hydrocarbyl group.

In some embodiments the R_{f}² group may be a fluorinated alkylene group to produce compounds of the formula:

R_{f}³(Y—NH—SO₂R¹)ₓ, VII

where
R_{f}³ represents a perfluoroalkylene group,
Y is a hydrocarbyl groups, including alkylene and arylene, and is preferably an alkylene of 2 or more carbons; and
subscript x is 2 to 8.

The R_{f}² group may also be a fluorinated ether or fluorinated polyether group to produce compounds of the formula:

[F—R_{f}³—O—R_{f}⁴—(R_{f}⁵)_{q}]—(Y—NH—SO₂R¹)ₓ, VIII

where [F—R_{f}³—O—R_{f}⁴—(R_{f}⁵)_{q}]— has a valence of x from abstraction of two or more F atoms from any of the R_{f}³, R_{f}⁴, or R_{f}⁵ groups, and
R_{f}³, R_{f}⁴, R_{f}⁵, subscript q, Y and R¹ are as previously defined.

In some embodiments the polysulfonamides of Formula I may be prepared by reaction of a sulfonyl halide compound with a di- or polyamine:

R¹SO₂—X+R²(NH₂)ₓ→I,

where R¹ is a fluorinated or non-fluorinated group and may be designated as Rₕ¹ or R_{f}¹ supra;
where R² may be a partially fluorinated group (R_{f}²) or a non-fluorinated groups (Rₕ²) and is a non-polymeric organic group that has a valence of x, and x is two to eight.

In some embodiments R² may selected from mono- and polyvalent (hetero)hydrocarbyl groups including aliphatic, cycloaliphatic, aromatic or alkyl-substituted aromatic having 1 to 30 carbon atoms and optionally zero to four catenary heteroatoms of oxygen, nitrogen or sulfur.

In some embodiments the R² group may be fluorinated designated as R_{f}² as described supra. Such compounds may be prepared by sulfonylation of fluorinated amines or the general formula R_{f}⁶(Y—NH₂)ₓ described in U.S. Pat. No. 8,907,120 (Yang et al.), U.S. Pat. No. 2,691,043 (Hustad et al.) and US 20122088216 (Baran et al.).

Useful (hetero)hydrocarbyl amines of the formula R²(NH₂)ₓ include aliphatic and aromatic polyamines. Aliphatic, aromatic, cycloaliphatic, and oligomeric di- and polyamines all are considered useful in the practice of the invention. Representative of the classes of useful di- or polyamines are 4,4′-methylene dianiline, 3,9-bis-(3-aminopropyl)-2,4,8,10-tetraoxaspiro[5,5]undecane, and polyoxyethylenediamine. Useful diamines include N-methyl-1,3-propanediamine; N-ethyl-1,2-ethanediamine; 2-(2-aminoethylamino)ethanol; pentaethylenehexaamine; ethylenediamine; N-methylethanolamine; and 1,3-propanediamine.

Examples of useful polyamines include polyamines having at least three amino groups, wherein at least one of the three amino groups are primary, and the remaining may be primary, secondary, or a combination thereof. Examples include H₂N(CH₂CH₂NH)₁₋₁₀H, H₂N(CH₂CH₂CH₂CH₂NH)₁₋₁₀H, H₂N(CH₂CH₂CH₂CH₂CH₂CH₂NH)₁₋₁₀H, H₂N(CH₂)₃NHCH₂CH═CHCH₂NH(CH₂)₃NH₂, H₂N(CH₂)₄NH(CH₂)₃NH₂, H₂N(CH₂)₃NH(CH₂)₄NH(CH₂)₃NH₂, H₂N(CH₂)₃NH(CH₂)₂NH(CH₂)₃NH₂, H₂N(CH₂)₂NH(CH₂)₃NH(CH₂)₂NH₂, H₂N(CH₂)₃NH(CH₂)₂NH₂, C₆H₅NH(CH₂)₂NH(CH₂)₂NH₂, and N(CH₂CH₂NH₂)₃,

Other useful di- or polyamines are 4,4′-methylene dianiline, 3,9-bis(3-aminopropyl)-2,4,8,10-tetraoxaspiro[5,5]undecane, and polyoxyethylenediamine. Many di- and polyamines, such as those just named, are available commercially, for example, those available from Huntsman Chemical, Houston, Tex.

The curing agent should be used in quantities substantial enough to cause the amorphous fluoropolymer to cure, as indicated by a rise in torque on a moving die rheometer. For example, at least 0.5-20 parts of the crosslinking agent per 100 parts of the amorphous fluoropolymer is used. If too little curing agent is used, the amorphous fluoropolymer will not cure. For example, no more than 20, 15, 10, or even 8 millimoles of the curing agent per 100 parts of the amorphous fluoropolymer is used. If too much curing agent is used, the amorphous fluoropolymer can become brittle.

One or a blend of polysulfonamide compounds with Formula I may be used, including any combination of polysulfonamide compounds of Formulas II, II and IV.

In addition to the polysulfonamide compound, the crosslinking component of the curable composition further comprises a blend with a fluorinated polyamine curing agent of the formula:

R_{f}—[(CH₂)_{y}—NH₂]ₓ, IX

where
R_{f} represents a perfluorinated groups including a perfluoroalkylene group or a perfluoroether group of valence x,
subscript y is 1 to 8;
subscript x is 2 to 4

The R_{f}¹⁰ perfluoroalkylene groups can contain straight chain, branched chain, or cyclic polyvalent perfluorinated groups in any combination and are of the general formula: —CₙF₂ₙ— for divalent groups, —CₙF₂ₙ₋₁— for trivalent groups, —CₙF₂ₙ₋₂— for tetravalent groups, etc. Divalent groups with n=2 to 8 being preferred and with n=3 to 5 being the most preferred. The compounds of Formula I will include the corresponding salts, or conjugate bases.

Minor amounts of hydrogen or chlorine atoms can also be present as substituents, provided that no more than one atom of either is present for every two carbon atoms. Preferably the R_{f} group is entirely perfluorinated.

The perfluoroalkylene groups may comprise 1 to 10 carbon atoms, preferably 2 to 6 carbon atoms. A typical divalent perfluoroalkylene is —CF₂—CF₂—, —CF₂—CF₂—CF₂—, —CF(CF₃)—CF₂—, —CF₂—, —CF₂—CF₂—CF₂—CF₂—CF₂—CF₂—, cyclic C₆F₁₂— or —CF(CF₃)—.

In some embodiments the R_{f}¹⁰ group may be selected from perfluoroether groups:

[R_{f}¹³—O—R_{f}¹⁴—(R_{f}¹⁵)_{q}]—[(CH₂)_{y}—OH]ₓ, where

[R_{f}¹³—O—R_{f}¹⁴—(R_{f}¹⁵)_{q}] has a valence of x from abstraction of two or more F atoms from any of the R_{f}¹³, R_{f}¹⁴, or R_{f}¹⁵ groups,
R_{f}¹³ represents a perfluoroalkylene group,
R_{f}¹⁴ represents a perfluoroalkyleneoxy group,
R_{f}¹⁵ represents a perfluoroalkylene group and q is 0 or 1
subscript y is 1 to 8; and
subscript x is 2 to 4.

Perfluorinated polyamines of Formula IX, where subscript y=1 are prepared by fluorination of a di- or higher acid to a perfluorinated acid fluoride, reaction with ammonia to the diamide and reduction to the diamine with BH3. Fluorinated amines of Formula VIII where y=2 can be prepared from reaction of the corresponding iodide with ethylene, followed by aminolysis. The process is similar to that described in U.S. Pat. No. 5,491,261 (Haniff et al.), incorporated herein by reference. Higher isomers may be prepared from the reaction of perfluoroiodo compounds using the procedure described in Malik et al., J. Org. Chem., 1991, 56, 3043-3044.

Generally, the molar ratio of polysulfonamide groups of the polysulfonamide compound to amine groups of the polyamine is from 1:1 to 1:36.

The crosslinking component, comprising a blend of the polysulfonamide compound and the polyamine compound, should be used in quantities substantial enough to cause the amorphous fluoropolymer to cure, as indicated by a rise in torque on a moving die rheometer. For example, at least 0.5-20 parts of the crosslinking agent per 100 parts of the amorphous fluoropolymer is used. If too little curing agent is used, the amorphous fluoropolymer will not cure. If too much curing agent is used, the amorphous fluoropolymer can become brittle. For example, no more than 20 millimoles of the curing agent per 100 parts of the amorphous fluoropolymer is used. One or a blend of polyamine compounds with Formula IX may be used in combination with the polysulfonamide.

In addition to the crosslinking component blend comprising the polysulfonamide compound and the polyamine compound, the curable composition may optionally include an additional optional crosslinking agent. Examples of the optional crosslinking agent include polyol compounds, polythiol compounds, polyamine compounds, amidine compounds, bisaminophenol compounds, oxime compounds, and the like.

Generally, examples are not restricted for selecting the specific combination of the polysulfonamides and polyamines, and secondary crosslinking agent and/or crosslinking promoter, depending on the type of polymer, but typical examples are presented below. For example, with a vinylidene fluoride system (binary system or ternary system), a polyol compound, polyamine compound, polythiophene compound is preferable. With a tetrafluoroethylene-propylene-vinylidene fluoride-based fluorine rubber (ternary) system, polyol compound, polyamine compound, polythiol compound, or the like is preferable.

Examples of preferable polyol compounds include 2,2-bis(4-hydroxyphenyl) hexafluoropropane, 4,4′-dihydroxy diphenyl sulfone, 4,4′-diisopropylidene bisphenol, and the like.

Examples of preferable polythiol compounds include 2-dibutyl amino-4,6-dimercapto-s-triazine, 2,4,6-trimercapto-s-triazine, and the like.

Examples of preferable polyamine compounds include hexamethylene diamine carbamate, N,N′-dicinnamylidene-1,6-hexanediamine, 4,4′-methylene bis(cyclohexylamine) carbonate, and the like.

Examples of preferable amidine compounds include p-toluene sulfonate salts of 1,8-diazabicyclo[5.4.0]undec-7-ene, and the like.

Examples of preferable bisaminophenol compounds include 2,2-bis(3-amino-4-hydroxyphenyl))-hexafluoropropane, 2,2-bis[3-amino-4-(N-phenylamino) phenyl]hexafluoropropane, and the like.

If using an optional second crosslinking agent, the molar ratios of the curing agent blend to the second crosslinking agent may be from 5:1 to 1:1.

The curable composition may further comprise an acid acceptor including organic, inorganic, or blends of thereof. Examples of inorganic acceptors include magnesium oxide, lead oxide, calcium oxide, calcium hydroxide, dibasic lead phosphate, zinc oxide, barium carbonate, strontium hydroxide, calcium carbonate, hydrotalcite, etc. Organic acceptors include amines, epoxies, sodium stearate, and magnesium oxalate. Particularly suitable acid acceptors include calcium hydroxide, magnesium oxide and zinc oxide. Blends of acid acceptors may be used as well. The amount of acid acceptor will generally depend on the nature of the acid acceptor used.

If the presence of an extractable metal compound is not desirable (such as semiconductor applications), the use of inorganic acid acceptors should be minimized, and these preferably should not be used at all. For example, a hardening composition with a formula that does not use an inorganic acid acceptor is particularly useful for sealing materials and gaskets for manufacturing semiconductor elements, sealing materials that are in contact with water, hot water, or the like, and sealing materials for high temperature areas such as automotive applications.

Examples of preferred acid acceptors that are commonly used include zinc oxide, calcium hydroxide, calcium carbonate, magnesium oxide, hydrotalcite, silicon dioxide (silica), lead oxide, and the like. These compounds are generally used in order to bond with HF and other acids. These acids are possibly produced at high temperatures that can be encountered during the hardening process when molding a molded article using the fluoropolymer composition, or at temperatures that demonstrate the function of fluoropolymers and the like.

In one embodiment, at least 0.5, 1, 2, 3, or even 4 parts of the acid acceptor per 100 parts of the amorphous fluoropolymer are used. In one embodiment, no more than 10, 7, or even 5 parts of the acid acceptor per 100 parts of the amorphous fluoropolymer are used.

The curable composition may further comprise an organo onium compound added to the composition as a phase transfer catalyst to assist with the crosslinking of the amorphous fluoropolymer and/or may be used to generate the double bonds on the fluoropolymer through dehydrofluorination. Such organo onium compounds include quaternary ammonium hydroxides or salts, quaternary phosphonium hydroxides or salts, and ternary sulfonium hydroxides or salts.

Briefly, a phosphonium and ammonium salts or compounds comprise a central atom of phosphorous or nitrogen, respectively, covalently bonded to four organic moieties by means of a carbon-phosphorous (or carbon-nitrogen) covalent bonds and is ionically associated with an anion. The organic moieties can be the same or different.

Briefly, a sulfonium compound is a sulfur-containing organic compound in which at least one sulfur atom is covalently bonded to three organic moieties having from 1 to 20 carbon atoms by means of carbon-sulfur covalent bonds and is ionically associated with an anion. The organic moieties can be the same or different. The sulfonium compounds may have more than one relatively positive sulfur atom, e.g. [(C₆H₅)₂S⁺(CH₂)₄S⁺(C₆H₅)₂]₂Cl⁻, and two of the carbon-sulfur covalent bonds may be between the carbon atoms of a divalent organic moiety, i.e., the sulfur atom may be a heteroatom in a cyclic structure.

Many of the organo-onium compounds useful in this invention are described and known in the art. See, for example, U.S. Pat. No. 4,233,421 (Worm), U.S. Pat. No. 4,912,171 (Grootaert et al.), U.S. Pat. No. 5,086,123 (Guenthner et al.), and U.S. Pat. No. 5,262,490 (Kolb et al.), U.S. Pat. No. 5,929,169, all of whose descriptions are herein incorporated by reference. Another class of useful organo-onium compounds include those having one or more pendent fluorinated alkyl groups. Generally, the most useful fluorinated onium compounds are disclosed by Coggio et al. in U.S. Pat. No. 5,591,804.

Exemplary organoonium compounds include: C₃-C₆ symmetrical tetraalkylammonium salts, unsymmetrical tetraalkylammonium salts wherein the sum of alkyl carbons is between 8 and 24 and benzyltrialkylammonium salts wherein the sum of alkyl carbons is between 7 and 19 (for example tetrabutylammonium bromide, tetrabutylammonium chloride, benzyltributylammonium chloride, benzyltriethylammonium chloride, tetrabutylammonium hydrogen sulfate and tetrabutylammonium hydroxide, phenyltrimethylammonium chloride, tetrapentylammonium chloride, tetrapropylammonium bromide, tetrahexylammonium chloride, and tetraheptylammonium bromidetetramethylammonium chloride); quaternary phosphonium salts, such as tetrabutylphosphonium salts, tetraphenylphosphonium chloride, benzyltriphenylphosphonium chloride, tributylallylphosphonium chloride, tributylbenzyl phosphonium chloride, tributyl-2-rnethoxypropylphosphonium chloride; benzyldiphenyl(dimethylamino)phosphonium chloride, 8-benzyl-1,8-diazobicyclo[5.4.0]7-undecenium chloride, benzyltris(dimethylamino)phosphonium chloride, and bis(benzyldiphenylphosphine)iminium chloride. Other suitable organo onium compounds include 1,8-diazabicyclo[5.4.0]undec-7-ene and 1,5-diazabicyclo[4.3.0]non-5-ene. Phenolate is a preferred anion for the quaternary ammonium and phosphonium salts.

In one embodiment, the organo onium compound is used between 1 and 5 millimoles per 100 parts of the amorphous fluoropolymer (mmhr).

The fluoropolymer composition can also contain various additives in addition to the aforementioned components. Examples of additives include crosslinking auxiliary agents and/or crosslinking promoting auxiliary agents that combine favorably with the crosslinking agent and/or crosslinking promoter used, fillers (such as carbon black, flowers of zinc, silica, diatomaceous earth, silicate compounds (clay, talc, wollastonite, and the like), calcium carbonate, titanium oxide, sedimentary barium sulfate, aluminum oxide, mica, iron oxide, chromium oxide, fluoropolymer filler, and the like), plasticizers, lubricants (graphite, molybdenum disulfide, and the like), release agents (fatty acid esters, fatty acid amides, fatty acid metals, low molecular weight polyethylene, and the like), colorants (cyanine green and the like), and processing aids that are commonly used when compounding fluoropolymer compositions, and the like. However, these additives are preferably sufficiently stable under the intended conditions of use.

Furthermore, the carbon black can be used to achieve a balance between fluoropolymer composition properties such as tensile stress, tensile strength, elongation, hardness, wear resistance, conductivity, processability, and the like. Preferable examples include MT blacks under the product numbers N-991, N-990, N-908, and N-907 (medium thermal black); FEF N-550; and large diameter furnace black, and the like. If carbon black is used, the amount is preferably from approximately 0.1 to approximately 70 mass parts per hundred resin (phr) based on 100 mass parts of the total amount of polymer containing fluorinated olefin units and the additional polymer. This range is particularly preferable for the case where large particle furnace black is used.

The curable amorphous fluoropolymer compositions may be prepared by mixing the amorphous fluoropolymer, the curing agent, along with the other components (e.g., the acid acceptor, the onium compound, and/or additional additives) in conventional rubber processing equipment to provide a solid mixture, i.e. a solid polymer containing the additional ingredients, also referred to in the art as a “compound”. This process of mixing the ingredients to produce such a solid polymer composition containing other ingredients is typically called “compounding”. Such equipment includes rubber mills, internal mixers, such as Banbury mixers, and mixing extruders. The temperature of the mixture during mixing typically will not rise above about 120° C. During mixing the components and additives are distributed uniformly throughout the resulting fluorinated polymer “compound” or polymer sheets. The “compound” can then be extruded or pressed in a mold, e.g., a cavity or a transfer mold and subsequently be oven-cured. In an alternative embodiment curing can be done in an autoclave.

Curing is typically achieved by heat-treating the curable amorphous fluoropolymer composition. The heat-treatment is carried out at an effective temperature and effective time to create a cured fluoroelastomer. Optimum conditions can be tested by examining the cured fluoroelastomer for its mechanical and physical properties. Typically, curing is carried out at temperatures greater than 120° C. or greater than 150° C. Typical curing conditions include curing at temperatures between 160° C. and 210° C. or between 160° C. and 190° C. Typical curing periods include from 3 to 90 minutes. Curing is preferably carried out under pressure. For example pressures from 10 to 100 bar may be applied. A post curing cycle may be applied to ensure the curing process is fully completed. Post curing may be carried out at a temperature between 170° C. and 250° C. for a period of 1 to 24 hours.

The partially fluorinated amorphous fluoropolymer in the curable composition has a Mooney viscosity in accordance with ASTM D1646-06 TYPE A by a MV 2000 instrument (available from Alpha Technologies, Ohio, USA) using large rotor (ML 1+10) at 121° C. Upon curing, using the curing agent disclosed herein, the amorphous fluoropolymer becomes an elastomer, becoming a non-flowing fluoropolymer, and having an infinite viscosity (and therefore no measurable Mooney viscosity).

The above curable compositions can be compounded or mixed in one or several steps, and then the mixture can be processed and shaped, for example, by extrusion (for example, in the form of a hose or hose lining) or molding (for example, in the form of an O-ring seal). The shaped article can then be heated to cure the composition and form a cured elastomer article.

In some embodiments the desired amounts of conventional additives adjuvants or ingredients are added to the uncured compositions and intimately admixed or compounded therewith by employing any of the usual rubber mixing devices such as Banbury mixers, roll mills, or any other convenient mixing device. The temperature of the mixture on the mill typically will not rise above about 120° C. During milling the components and adjuvants are distributed uniformly throughout the gum. The curing process typically comprises extrusion of the compounded mixture or pressing the compounded mixture in a mold, e.g., a cavity or a transfer mold, and subsequent oven-curing. Pressing of the compounded mixture (press cure) is usually conducted at a temperature between about 95 and about 230° C., preferably between about 150° C. and about 205° C. for a period of from 1 minute to 15 hours, typically from 5 minutes to 30 minutes. A pressure of between about 700 kPa and about 20,600 kPa is usually imposed on the compounded mixture in the mold. The molds first may be coated with a release agent, such as a silicone oil, and prebaked. The molded vulcanizate is then usually post-cured (oven-cured) at a temperature usually between about 150° C. and about 315° C. for a period of from about 2 hours to 50 hours or more depending on the cross-sectional thickness of the article.

The compositions of this invention can be used to form seals, O-rings and gaskets. The cured fluorocarbon elastomer mixture has excellent low-temperature flexibility while retaining the desired physical properties, for example tensile strength and elongation, of conventionally compounded and cured compositions. Particularly useful articles that can be fabricated from the fluorocarbon elastomer compositions of this invention are particularly useful as seals, gaskets, and molded parts in automotive, chemical processing, semiconductor, aerospace, and petroleum industry applications, among others.

### EXAMPLES

### Examples

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Mo., or may be synthesized by known methods. Table 1 (below) lists materials used in the examples and their sources.

TABLE 1
Materials List

| DESIGNATION | DESCRIPTION |
|---|---|
| C11 | C4F9-Alkyl di-sulfonamide: C₄F₉—SO₂—NH—C₈H₁₆—NH—SO₂—C₄F₉, |
| | which can be prepared as described for Example 2 of U.S. Pat. No. 3,829,466. |
| C12 | CH3-Fluoroalkyl di-sulfonamide: CH₃—NH—SO₂—C₄F₈—SO₂—NH—CH₃, |
| | prepared as described in Example 1 of U.S. Pat. No. 2,803,656, but with |
| | perfluorobutyldisulfonyl fluoride from 3M Company, Maplewood, MN, USA. |
| | and methylamine available from Sigma-Aldrich Company. |
| C13 | Alkyl di-sulfonamide: CH₃—SO₂—NH—C₆H₁₂—NH—SO₂—CH_{3,} |
| | prepared as described in PE-1 below. |
| C8 | C6-Diamine: H₂N—CH₂—C₂F₄—O—C₂F₄—CH₂—NH₂, 2,2,8,8- |
| | tetrahydro-3,4,6,7-octafluoro-5-oxa-nonan-1,9-diamine, prepared as described |
| | in PE-2 below. |
| FC 2145 | A low-viscosity copolymer of hexafluoropropylene and vinylidene fluoride |
| | that does not include an incorporated curative, available under the trade |
| | designation “3M 3M/DYNEON FLUOROELASTOMER FC 2145” from 3M |
| | Company, Maplewood, MN, USA. |
| N990 | Carbon black, available under the trade designation “N990” from Cancarb, |
| | Medicine Hat, Alberta, Canada |
| MgO | An acid acceptor. Magnesium oxide powder commercially available under the trade |
| | designation “ELASTOMAG 170” from Akrochem Corp., Akron, OH, USA |
| Ca(OH)₂ | An acid acceptor. Calcium hydroxide commercially available under the trade |
| | designation “HALLSTAR CALCIUM HYDROXIDE HP-XL” from The Hallstar |
| | Company, Chicago, IL, USA |
| TPBPC | Triphenylbenzyl phosphonium chloride, available from Sigma-Aldrich Company, |
| | diluted to 50% by weight in methanol, also available from Sigma-Aldrich |
| Bisphenol-AF | Bisphenol-AF, curing agent, obtained from Sigma-Aldrich Company, St. Louis, |
| | MO, USA |

### Preparative Example 1 (PE-1): C13

To a 3-necked round-bottom flask was added 49 grams (g) (0.4517 mole (mol)) of triethyl amine, 25 g (0.2151 mol) hexamethylene diamine and 200 milliliter (mL) of toluene at 35° C. To this was added 5 dropwise a solution of 114.6 g (0.4302 mol) of methane sulfonylchloride. An exotherm occurred which raised the temperature to 95° C., despite cooling the flask in an ice bath. The contents of the flask were allowed to cool to 70° C. and heated for another hour, before 300 mL of water was added at ambient temperature. This mixture was allowed to mix for 30 minutes. The resulting slurry was filtered and the precipitate was washed 5 times with 200 mL water, followed by two times with 200 mL 2-propanol. The cake was then dried at 40° C. in an oven for 5-6 hours. Preparative Example 2 (PE-2): C8

In a 1 liter (L) 3-neck round bottom flask equipped with a mechanical stirrer, thermocouple, dry-ice condenser and a rubber septum was charged with 500 g (1.5 mol) of CH₃OCOC₂F₄—O—C₂F₄CO₂CH₃, dimethyl perfluorooxydipropionate (made from acrylonitrile reaction with water followed by methanolysis then direct fluorination as described in U.S. Pat. No. 5,399,718 (Costello et al.)) along with 1200 g methanol and stirred. Addition of ammonia (54 g, 3.2 mol) was done by way of a cannula placed through the rubber septum. A water bath was used to keep the reaction temperature below 43° C. as ammonia was added over 1 hour. After ammonia addition volatiles were removed by rotary evaporation to give 453 g diamide in quantitative yield. Borane (49.5 g, 1.7 mol) was made by addition of NaBH₄ (101 g, 2.6 mol) and 2000 g THF in a 5 L 3-neck round bottom flask equipped with a mechanical stirrer, water condenser, thermocouple, and addition funnel and stirred. Reaction temperature was kept at 10° C. by a cooling bath and BF₃ etherate (500 g, 7.3 mol) was added over 2 hours. After addition was complete the reaction was heated to 54° C. with refluxing for 30 minutes. The reaction was cooled to 10° C. and dropwise addition of a 50% solution in THF of diamide (250 g, 0.82 mol) was done over 2 hours. Temperature was held at 25° C. for 1 hour followed by heating to 64° C. for 20 hours. The mixture was cooled to 25° C. and a solution of HCl (170 g in 500 g deionized water) was added and stirred. The reaction was made basic by addition of NaOH and 500 g of methyl tert-butyl ether (MTBE) was used to extract out the diamine. Vacuum distillation gave NH₂CH₂C₂F₄—O—C₂F₄CH₂NH₂ (112 g, 0.4 mol) boiling at 50-60° C. at 1 millimeter (mm Hg) for a 50% yield. GCMS confirmed the structure.

### Compounding

150 g batches of fluoropolymer were compounded with 0.78 parts per hundred resin (phr) of TPBPC, various amounts of curing agent as indicated in Table 2, 6 phr of Ca(OH)₂, 3 phr of MgO, and 20 phr of N990 carbon black, using a two-roll mill. Milling continued until a homogeneous blend formed. Ca(OH)₂, MgO, and N990 were added as a mixture. The ratios of each component in examples and comparative examples are indicated as phr in Table 2, below.

TABLE 2
Compounding

| EXAMPLE | CE-1 | CE-2 | EX-1 | EX-2 | Ex-3 |
|---|---|---|---|---|---|
| FC 2145, part | 100 | 100 | 100 | 100 | 100 |
| TPBPCl, phr | 0.78 | 0.78 | 0.78 | 0.78 | 0.78 |
| Bisphenol-AF, phr | 2.02 | — | — | — | — |
| C11, phr | — | — | 1.42 | — | — |
| C12, phr | — | — | — | 0.78 | — |
| C13, phr | — | — | — | — | 0.54 |
| C8, phr | — | 1.66 | 1.66 | 1.66 | 1.66 |
| N990, phr | 20 | 20 | 20 | 20 | 20 |
| Ca(OH)₂, phr | 3 | 3 | 3 | 3 | 3 |
| MgO, phr | 6 | 6 | 6 | 6 | 6 |

### Cure Rheology

Cure rheology tests were carried out using uncured, compounded samples using a moving die rheometer (MDR) marketed under the trade designation RPA 2000 by Alpha technologies, Akron, Ohio, in accordance with ASTM D 5289-93a at 177° C., no pre-heat, 12 minute elapsed time, and a 0.5 degree arc. The minimum torque (M_{L}), maximum torque (M_{H}), the time for the torque to reach a value equal to M_{L}+0.5(M_{H}−M_{L}), (t′50), and the time for the torque to reach M_{L}+0.9(M_{H}−M_{L}), (t′90), the scorch time (Ts2), and Tan delta at maximum torque were measured and their values are listed in Table 3.

### Press-Cure Molding and Physical Property Test

The compound was press-cured using a mold (size: 75 millimeters (mm)×150 mm×2 mm or 150 mm×150 mm×2 mm) at 6.5×10³ kilopascals (kPa) and 177° C. for 10 minutes. Then the elastomer sheets were removed, cooled to room temperature, and then used for physical property test and post-cure. The dog bone specimens were cutout from the sheets with ASTM Die D and subjected to physical property testing similar to the procedure disclosed in ASTM D412-06a (2013). The typical tensile strength deviation is +/−1.4 MPa (200 psi). The typical elongation deviation is +/−25%. Hardness is +/−2. The test results are summarized in Table 3.

### Post-Cure and Physical Property Test

The press-cured elastomer sheet was post cured at 232° C. for 16 hours in a circulating air oven. The samples were then removed from the oven, cooled to room temperature, and physical properties determined. The dog bone specimens were cutout from the sheets with ASTM Die D and subjected to physical property testing similar to the procedure disclosed in ASTM D412-06a (2013). The test results are summarized in Table 3.

### Heat-Aging and Physical Property Test

The dog bone specimens of post-cured samples were placed in a circulating air oven for 70 hours at 270° C. The samples were then removed from the oven and cooled to room temperature for measurement of physical properties according to ASTM D412-06a (2013). The test results are summarized in Table 3.

### O-Ring Molding and Compression Set Test

O-rings having a cross-section thickness of 0.139 inch (3.5 mm) were molded at 6.5×10³ kPa and 177° C. for 10 minutes and then post-cured at 232° C. for 16 hours. The O-rings were subjected to compression set testing similar to the procedure disclosed in ASTM D 395 Method B (2008), with 25% initial deflection. Results of compression test are reported in Table 3.

TABLE 3
Curable fluoropolymer curing characteristics,
and properties of cured fluoropolymers

| | | | | | |
|---|---|---|---|---|---|
| Curing Characteristics | CE-1 | CE-2 | EX-1 | EX-2 | EX-3 |

Moving Die Rheometer, 0.5° at 177° C. (350° F.) 12 minute motor

| | | | | | |
|---|---|---|---|---|---|
| Minimum torque, | 0.06 | 0.35 | 0.04 | 0.1 | 0.18 |
| M_{L}, N · m | | | | | |
| Maximum torque, | 1.79 | 0.54 | 0.72 | 0.84 | 0.66 |
| M_{H}, N · m | | | | | |
| M_{H} − M_{L}, N · m | 1.73 | 0.19 | 0.68 | 0.75 | 0.48 |
| Ts2, minutes | 0.62 | * | 2.34 | 0.61 | 1.25 |
| t′50, minutes | 0.73 | 2.74 | 3.8 | 0.9 | 1.4 |
| t′90, minutes | 1.06 | 9.07 | 8.86 | 6.09 | 7.81 |
| Tan delta at maximum | 0.042 | 0.185 | 0.361 | 0.118 | 1.637 |
| torque | | | | | |

Properties of Cured Gumstocks
Physical Properties, press cure 10 minutes at 177° C. (350° F.)

| | | | | | |
|---|---|---|---|---|---|
| Durometer, shore A | 66 | ** | 60 | 63 | 63 |
| Tensile, MPa | 10.24 | ** | 13.14 | 11.91 | 11.93 |
| Elongation, % | 239 | ** | 494 | 523 | 500 |
| 100% Modulus, MPa | 3.31 | ** | 1.80 | 1.97 | 1.99 |

Physical Properties, post cure 16 hours at 232° C. (450° F.)

| | | | | | |
|---|---|---|---|---|---|
| Durometer, shore A | 67 | ** | *** | 67 | *** |
| Tensile, MPa | 14.05 | ** | *** | 14.20 | *** |
| Elongation, % | 191 | ** | *** | 318 | *** |
| 100% Modulus, MPa | 4.52 | ** | *** | 2.63 | *** |

Physical Properties, heat aging 70 hours at 270° C. (518° F.)

| | | | | | |
|---|---|---|---|---|---|
| Durometer, shore A | 74 | ** | *** | 73 | *** |
| Tensile, MPa | 7.45 | ** | *** | 11.84 | *** |
| Elongation, % | 151 | ** | *** | 218 | *** |
| 100% Modulus, MPa | 4.50 | ** | *** | 5.00 | *** |

Compression Set, 70 hours at 200° C. (392° F.)

| | | | | | |
|---|---|---|---|---|---|
| Compression Set, % | 21 | ** | 58.1 | 55.5 | 59.9 |

* not measurable.
** did not form a good molded products due to a scorch.
*** not measured due to defects after post cure.

1. A curable composition comprising:
a partially fluorinated amorphous fluoropolymer,
optionally an organo-onium accelerator
an acid acceptor; and
a crosslinking component comprising a blend of a polysulfonamide compound and a fluorinated polyamine compound.

2. The curable composition of claim 1 wherein the fluorinated polyamine is of the formula
R_{f}—[(CH₂)_{y}—NH₂]ₓ, where
R_{f} represents a perfluorinated groups including a perfluoroalkylene group or a perfluoroether group of valence x,
subscript y is 1 to 8;
subscript x is 2 to 4.

3. The curable composition of claim 1 wherein R_{f} is a C₂-C₈ perfluoroalkylene.

4. The curable composition of claim 1 wherein R_{f} is selected from divalent —CₙF₂ₙ—, trivalent —CₙF₂ₙ₋₁— and tetravalent —CₙF₂ₙ₋₂— where n=2 to 8.

5. The curable composition of claim 1 wherein the fluorinated polyamine is of the formula
[R_{f}¹³—O—R_{f}¹⁴—(R_{f}¹⁵)_{q}]—[(CH₂)_{y}—NH₂]ₓ, where
[R_{f}¹³—O—R_{f}¹⁴—(R_{f}¹⁵)_{q}] has a valence of x from abstraction of two or more F atoms from any of the R_{f}¹³, R_{f}¹⁴ or R_{f}¹⁵ groups,
R_{f}¹³ represents a perfluoroalkylene group,
R_{f}¹⁴ represents a perfluoroalkyleneoxy group,
R_{f}¹⁵ represents a perfluoroalkylene group and q is 0 or 1
subscript y is 1 to 8; and
subscript x is 2 to 4.

6. The curable composition of claim 1 wherein the fluorinated polyamine is of the formula
R_{f}—[(CH₂)_{y}—NH₂]ₓ, II where
R_{f} represents a perfluoroalkylene or perfluoroether group of valence x,
subscript y is 1 to 8; and
subscript x is 2 to 4.

7. The curable composition of claim 1 wherein the polysulfonamide is of the formula:
R²(NH—SO₂R¹)ₓ, where
R¹ is a non-fluorinated or fluorinated group,
R² is a partially fluorinated or non-fluorinated group,
subscript x is 2 to 8.

8. The curable composition of claim 7 wherein R¹ is a perfluorinated group R_{f}¹.

9. The curable composition of claim 8 wherein R_{f}¹ is a C₂-C₆ perfluoroalkyl.

10. The curable composition of claim 7 wherein R_{f}¹ is a perfluoroether group.

11. The curable composition of claim 7 wherein R_{f}¹ is a perfluoroether group of the formula F—R_{f}³—O—R_{f}⁴—(R_{f}⁵)_{q}—
wherein
R_{f}³ represents a perfluoroalkylene group,
R_{f}⁴ represents a perfluoroalkyleneoxy group,
R_{f}⁵ represents a perfluoroalkylene group and q is 0 or 1.

12. The curable composition of claim 7 wherein the fluorinated polysulfonamide is of the formula Rₕ²(NH—SO₂R_{f}¹)ₓ,
wherein Rₕ² is a (hetero)hydrocarbyl group, and R_{f}¹ is a perfluoroalkyl or perfluoroether group.

13. The curable composition of claim 7 wherein R² is a C₂-C₃₀ aliphatic, cycloaliphatic, aromatic or alkyl-substituted aromatic hydrocarbyl group of valence x designated as Rₕ².

14. The curable composition of claim 13 wherein Rₕ² is derived from a polyamine.

15. The curable composition of claim 7 wherein R² is a fluorinated group of the formula R_{f}⁶(Y—)ₓ—, where R_{f}⁶ represents a perfluoroalkylene or perfluoroether group, and Y is a hydrocarbyl group and subscript x is 2-8.

16. The curable composition of claim 7 wherein the polysulfonamide is of the formula
R_{f}²(Y—NH—SO₂R¹)ₓ,
where
R_{f}² represents a perfluoroalkylene group or perfluoroether group,
R¹ is a hydrocarbon group including aryl and alkyl,
Y is a hydrocarbyl groups, including alkylene and arylene, and is preferably and alkylene of 1 to 4 carbons; and
subscript x is 2 to 8.

17. The curable composition of claim 16 wherein R_{f}² is a perfluoroether group.

18. The curable composition of claim 17 wherein the polysulfonamide is of the formula
[F—R_{f}³—O—R_{f}⁴—(R_{f}⁵)_{q}]—(Y—NH—SO₂R¹)ₓ, where
[F—R_{f}³—O—R_{f}⁴—(R_{f}⁵)_{q}] has a valence of x from abstraction of two or more F atoms from any of the R_{f}³, R_{f}⁴, or R_{f}⁵ groups,
R_{f}³ represents a perfluoroalkylene group,
R_{f}⁴ represents a perfluoroalkyleneoxy group,
R_{f}⁵ represents a perfluoroalkylene group
R¹ is a non-fluorinated or fluorinated group,
Y is a hydrocarbyl groups, including alkylene and arylene, and is preferably and alkylene of 1 to 4 carbons; and
and q is 0 or 1.

19.-29. (canceled)

30. A molded article comprising the cured compositions of claim 1.

31. A method of preparing a shaped article comprising the steps of:
providing the curable composition of claim 1,
heating said composition to a temperature sufficient to cure the composition; and
recovering the shaped article.
